(19) United States
(12) Patent Application Publication
(10) Pub. No.: US 2004/0039583 A1
(43) Pub. Date: Feb. 26, 2004

(54) Information space providing system and method

(76) Inventors: Seiichiro Saito, Hino-shi (JP); Takahiro Saito, Yokohama-shi (JP); Takashi Fujiwara, Kawasaki-shi (JP); Kenichi Mori, Fujisawa-shi (JP); Ken Tanaka, Tokyo (JP); Hideki Yasukawa, Fujisawa-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/243,755

(22) Filed: Sep. 16, 2002

(30) Foreign Application Priority Data
Jun. 18, 2002 (JP) 2002-176881

(51) Int. Cl. G06F 17/60

(52) U.S. Cl. 705/1

(57) ABSTRACT

A system for providing an information space onto a network has a user mediation section for exchanging information with users, and a supply mediation section for exchanging information with information supply sections. The system has a basic data management section for storing basic data which includes a table that indicates correspondence between the information supply sections and key symbols, and a plurality of materials used to form an information space. The system also has a space management section including a space producer and space manager. The space producer forms an information space corresponding to a key symbol in response to a key symbol that represents a search target of each user. The space manager provides each information space to the corresponding user while placing a character that represents actions of the corresponding user in the information space.

### CROSS-REFERENCE TO RELATED APPLICATIONS

This application is based upon and claims the benefit of priority from the prior Japanese Patent Application No. 2002-176881, filed Jun. 18, 2002, the entire contents of which are incorporated herein by reference.

### BACKGROUND OF THE INVENTION

1. Field of the Invention

The present invention relates to a system and method for providing, onto a network, an information space that allows the user to access information supply sections.

2. Description of the Related Art

“Communication tools” and “information collection tools” are set on sites that can be accessed by user terminals, each of which comprises, e.g., a personal computer or the like, via transmission paths of a network and, especially, the Internet (public communication network), and such tools are used by users. Typical communication tools include a BBS (Bulletin Board System) and Chat. Typical information collection tools include a search engine.

The BBS is implemented by a CGI (Common Gateway Interface) on an HTTP (Hypertext Transfer Protocol) server. The user normally accesses the BBS using a browser, and posts a message as text data. Since many unspecified users post messages there, communications are established. There are some variations of BBSs depending on their CGIs, and they have features: realtimeness of communications is poor; users are less constrained by time due to poor realtimeness; logs are easy to browse; and so forth.

In general, the BBS is used as a site where users who share a common interest make communications. However, the use purpose of the BBS is entrusted to the BBS provider. Also, there are many different providing methods. Poor realtimeness is an advantage since users are less constrained by time, but is a serious problem for users who want quick responses. Furthermore, users must actively search a broad Internet space for a BBS helpful for himself or herself, and there is no assurance that an optimal BBS is surely found even if they conducted such search.

Chat is a system in which many unspecified users have conversations in real time via a network. Chat may be implemented by a CGI on an HTTP server, or by a dedicated server and client. As the type of Chat, a system in which users have conversations by only text, and a system in which characters called “avatars” that substitute for users have conversations in a virtual space on the network are available.

In a normal Chat system, many unspecified users make text-based communications. The network realtime IRC (Internet Relay Chat) or the like, which was developed in Rep. of Finland in 1988, and began to be used even in Japan since 1990, is popularly used. Since text-based information is exchanged, the information transfer size on the network can be small, and no broadband network environment is required. Such chat system is easy to use, but it is difficult to express user's delicate feelings or to express something through nuance.

On the other hand, in an avatar-based Chat system, an avatar that substitutes for user's actions works in a virtual space on the network and communicates with other “avatars”. With such “avatars”, the user can convey intended nuances that cannot be expressed by text-based communications. As such system, some sites are currently available. In these sites, the provider builds a virtual space, in which avatars work to form a community.

As avatar-based Chat systems, 2D (two-dimensional) Chat that uses a 2D virtual space, and 3D (three-dimensional) Chat that uses a 3D virtual space are known. The avatar-based 2D and 3D Chat systems have differences that their worlds are built in 2D or 3D, are broad or narrow, and the number of types of avatars is large or small. However, these 2D and 3D Chat systems are worlds which are basically built according to the same idea.

In an existing Chat system, a user can work in only the world built by the provider, and a partner with whom a given user wants to communicate is not always in that world. On the whole, the Chat system can be considered as a BBS with high realtimeness. That is, the Chat system also takes over the drawbacks of the BBS, i.e., the user must search a broad Internet space for a Chat site suitable for himself or herself, and cannot always find an optimal Chat site.

The search engine allows the user to input a keyword and to collect information of sites associated with that keyword. As a mechanism, the search engine has a site database, and searches that database using the designated word. Upon generating a database, there are two types, i.e., a robot periodically collects information from the Internet, and site creators actively register their sites in the engine.

The search engine has only a function of searching for sites on the Internet, but cannot collect required information by other means. The search engine is effective to some extent when a personal user solely conducts a research, but is unsatisfactory as an information collection means.

Therefore, it is hard to say that the aforementioned existing systems and methods provide an information system which is optimal for a user who wants to collect information.

### BRIEF SUMMARY OF THE INVENTION

According to the first aspect of the present invention, there is provided a system for providing an information space on a network, comprising:

a user mediation section configured to selectively exchange information with a plurality of users;

a supply mediation section configured to selectively exchange information with a plurality of information supply sections;

a basic data management section configured to store basic data including a table that indicates correspondence between the information supply sections and a plurality of key symbols, and a plurality of image materials used to form an information space; and

a space management section that includes a space producer which selects, in response to an input key symbol that represents a search target of each user, information supply sections relevant to the key symbol and image materials that represent the information supply sections from the basic data with reference to the table, and forms an information space corresponding to the key symbol using the selected image materials, and a space manager which provides each information space to a corresponding user via the user mediation section while placing a character that substitutes for actions of the corresponding user in the information space, and manages the information space to allow the corresponding user to selectively access an arbitrary information supply section via the supply mediation section by selecting an image material in the information space.

According to the second aspect of the present invention, there is provided a method of providing an information space onto a network using a system which has a user mediation section configured to selectively exchange information with a plurality of users, and a supply mediation section configured to selectively exchange information with a plurality of information supply sections, comprising:

storing basic data including a table that indicates correspondence between the information supply sections and a plurality of key symbols, and a plurality of image materials used to form an information space;

selecting, in response to an input key symbol that represents a search target of each user, information supply sections relevant to the key symbol and image materials that represent the information supply sections from the basic data with reference to the table, and forming an information space corresponding to the key symbol using the selected image materials; and

providing each information space to a corresponding user via the user mediation section while placing a character that substitutes for actions of the corresponding user in the information space, and managing the information space to allow the corresponding user to selectively access an arbitrary information supply section via the supply mediation section by selecting an image material in the information space.

### BRIEF DESCRIPTION OF THE SEVERAL VIEWS OF THE DRAWING

FIG. 1 is a block diagram showing a basic concept of the relationship among an information space providing system, user terminals, and information supply sections according to the first embodiment of the present invention;

FIG. 2 shows an example of an information space defined by a 3D space provided to the user in the first embodiment;

FIG. 3 is a block diagram showing an information space providing system according to the second embodiment of the present invention;

FIG. 4 is a flow chart until the user establishes connection to a city associated with information that he or she wants to get hold of in the second embodiment;

FIG. 5 is a flow chart until the user is provided with a city associated with information that he or she wants to get hold of in the second embodiment;

FIG. 6 is a view showing the principle of connection among cities as information space units in the second embodiment;

FIG. 7 is a view showing a basic concept of a typical building layout in a city as an information space unit in the second embodiment;

FIG. 8 is a flow chart showing a process for updating a material database and city database in the second embodiment;

FIG. 9 shows a practical example upon statistically updating the connection state among cities in the second embodiment;

FIG. 10 shows a practical example upon statistically updating the internal configuration of a city in the second embodiment;

FIG. 11 shows a practical example of an information space using an atmosphere file in the material database in the second embodiment;

FIG. 12 is a flow chart showing communications in the second embodiment;

FIG. 13 is a flow chart showing a city rendering process in the second embodiment;

FIGS. 14A and 14B respectively show a basic concept associated with connection among cities and a rendering example in the second embodiment;

FIG. 15 shows a display example of an information space in the second embodiment;

FIG. 16 shows another display example of an information space in the second embodiment;

FIG. 17 shows a display example of an information space including a replay post; and

FIG. 18 shows a basic concept of cooperation between an information space and real world in the second embodiment.

### DETAILED DESCRIPTION OF THE INVENTION

Embodiments of the present invention will now be described with reference to the accompanying drawings. In the following description, the constituent elements having substantially the same function and arrangement are denoted by the same reference numerals, and a repetitive description will be made only when necessary.

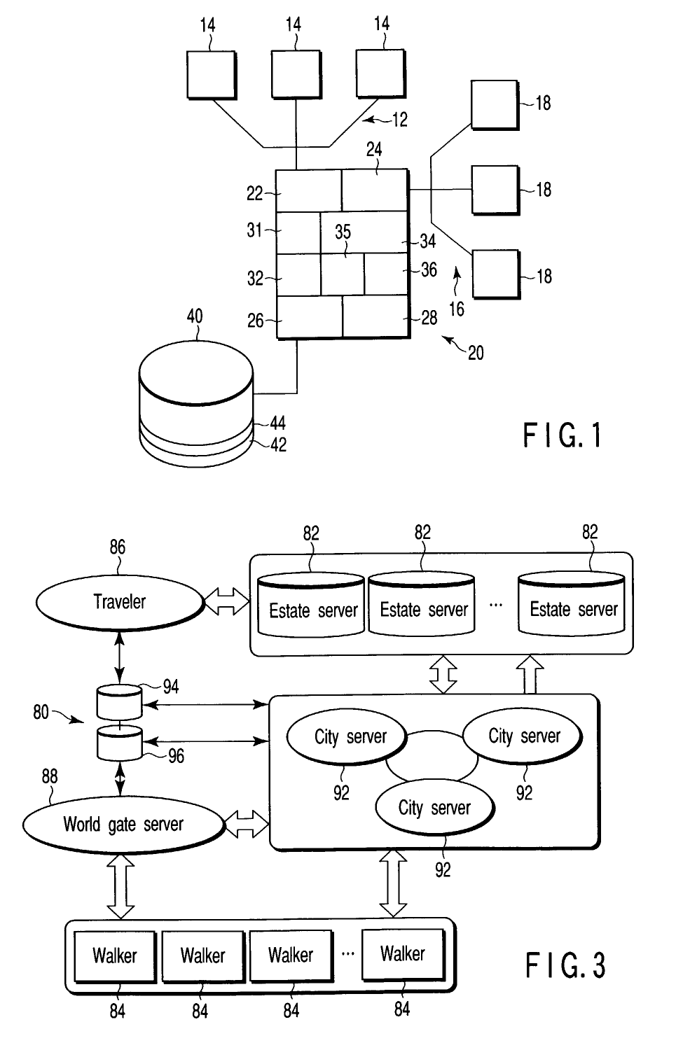

FIG. 1 is a block diagram showing a basic concept of the relationship among an information space providing system, user terminals, and information supply sections according to the first embodiment of the present invention.

In this embodiment, a system 20 that provides an information space is set in a site that can be accessed by user terminals 14, each of which comprises a personal computer or the like, via transmission paths of a network 12 and, especially, the Internet (public communication network). Hence, a host computer of the information space providing system 20 has a user mediation section 22 that serves as a window for selectively exchanging information with a plurality of users, and the section 22 is connected to the network 12.

The information space providing system 20 has a supply mediation section 24 that serves as a window for selectively exchanging information with a plurality of information supply sections 18. Each information supply section 18 is like an information site which is currently accessible on the Internet, and has its own contents. The supply mediation section 24 is connected to the information supply sections 18 via transmission paths of a dedicated or public network 16. The network 12 on the user mediation section 22 side may be the same as or different from the network 16 on the supply mediation section 24 side.

In order to manage basic data required to provide an information space onto the network, a basic data management section 26 is connected to the information space providing system 20. A basic data file 42 is formed in a storage section 40 of the information space providing system 20 in correspondence with the basic data management section 26. The basic data file 42 stores basic data including a table which indicates correspondence between the information supply sections 18 and a plurality of key symbols (e.g., words) that represent the contents of the information supply sections 18, a plurality of image materials used to form an information space, and the like.

In order to update the basic data in the basic data file 42, the information space providing system 20 includes a data update section 28. The data update section 28 periodically or non-periodically patrols the information supply sections 18 via the supply mediation section 24 and network 16. If the contents or the like of the information supply sections 18 have changed, the data update section 28 updates the basic data such as the table which indicates correspondence between the information supply sections 18 and key symbols.

In order to provide an information space to the users using the basic data in the basic data file 42, the information space providing system 20 includes a space search section 32 and space management section 34. A space management file 44 is formed in the storage section 40 of the information space providing system 20 in correspondence with the space management section 34. The space management file 44 stores the state of an information space formed in a manner to be described later, the relationship between the information space and key symbols, and the like.

The space management section 34 includes a space producer 35 for forming an information space, and a space manager 36 for managing the information space. The space search section 32 and space management section 34 are provided with a translation means 31. The translation means 31 translates key data such as a word, picture, sound, or the like, which is input by each user via the terminal 14 and user mediation section 22, and represents a search target, into a key symbol registered in the aforementioned basic data.

When the translation means 31 translates key data to obtain a key symbol, the space search section 32 searches a plurality of existing information spaces stored in the space management file 44 for a space which corresponds to or pertains to the key symbol. If the space search section 32 finds the corresponding space, it informs the space management section 34 of that found space as an information space corresponding to the key symbol. If the space search section 32 cannot find any space, it instructs the space management section 34 to form an information space corresponding to that key symbol.

Upon forming an information space, the key symbol is input to the space producer 35. The space producer 35 selects information supply sections 18 associated with the key symbol, and image materials which represent it from the basic data with reference to the aforementioned correspondence table in the basic data file 42. Then, the space producer 35 forms an information space corresponding to the key symbol using the selected image materials.

The space manager 36 stores the formed information space in the space management file 44. The space manager 36 provides each information space to the corresponding user via the user mediation section 22 while laying out a character, e.g., an avatar (virtual personality) that substitutes for corresponding user's actions in the information space. The user can selectively access an arbitrary information supply section 18 via the supply mediation section 24 by selecting an image material in the image in each information space.

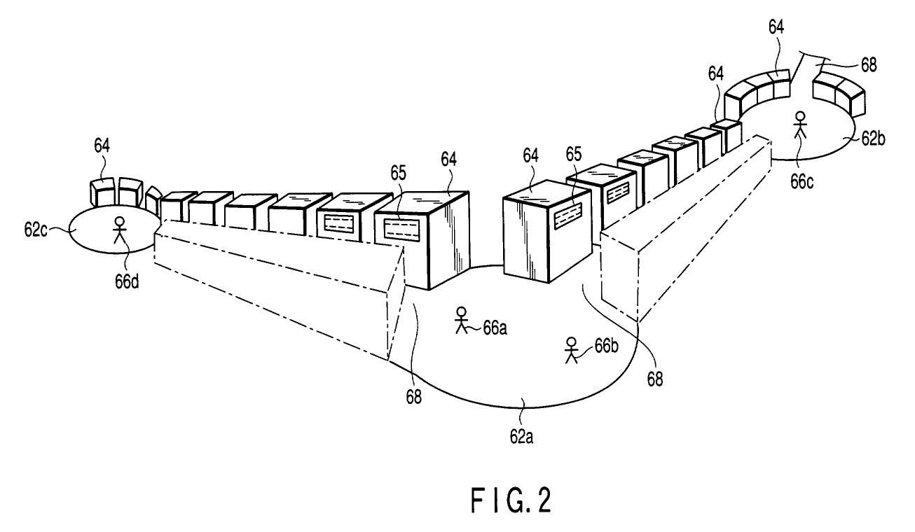

FIG. 2 shows an example of an information space as a 3D space which is formed by the space producer 35 and is provided to the user by the space manager 36 in the first embodiment. As shown in FIG. 2, buildings 64 as image materials which represent the respective information supply sections 18 are radially arranged to have open spaces 62a to 62c as the centers. Comments 65 are appended to the respective buildings 64, and users can understand the contents of the information supply sections 18 represented by these buildings 64 via these comments 65. Each user visits a building 64 via a character (e.g., an avatar 66a) as a representation of himself or herself, and can browse information possessed by that building 64.

Image materials (mainly the buildings 64 in the example of FIG. 2) are displayed to have larger sizes on the near side, as the relevancy with the key symbol is higher, and in accordance with the specification (freshness, degree of matching, importance, rating) of user's choice. The space management section 34 can assign different image materials as those which represent the respective information supply sections, in accordance with the key symbol, so that the information space has an atmosphere which matches the key symbol. Note that image materials (building, tree, mountain, river, and the like) captured from a real world can be used.

As shown in FIG. 2, a plurality of avatars 66a to 66d that represent a plurality of users are placed in this information space. The avatars placed in the identical information space indicate that the users represented by them have an interest in the same or closely associated search targets. These avatars can have conversations with each other (communicate via the space management section 34 and user mediation section 22) in the common information space and can exchange information.

As a typical example, key symbols that represent search targets of the first and second users are related to each other, and a first information space for the first user has already been formed and managed by the space manager 36. In this case, the space search section 32 finds the presence of the first information space based on the key symbol of the second user, and informs the space management section 34 of that result. Based on this information, the space manager 36 assigns the first information space, in which the first avatar has already been placed, to the second user, additionally places the second avatar that represents the second user in that space, and provides the first information space to the second user.

As shown in FIG. 2, this information space is formed by connecting a plurality of open spaces 62a to 62c via roads 68. Each of the open spaces 62a to 62c represents an information space unit formed based on one key symbol. The space manager 36 connects a plurality of information space units formed based on a plurality of closely associated key symbols via roads (connectors) 68. Each of the avatars 66a to 66d that represent the respective users can freely wander up and down among the open spaces (information space units) 62a to 62c wherever he or she wants to go by moving along the roads 68.

Along the roads 68 that connect the open spaces 62a to 62c, the contents of the information supply sections 18 represented by the buildings 64 change gradually. For example, along the road 68 that connects the first and second open spaces 62a and 62b formed based on the first and second key symbols, the contents represented by the buildings 64 become less relevant to the first key symbol but more relevant to the second key symbol from the first open space 62a toward the second open space 62b.

The width, configuration, atmosphere, and the like of each of the roads (connectors) 68 which connect the open spaces 62a to 62c can be changed in accordance with the frequency of use of the road 68. For example, when the avatars 66a to 66d frequently come and go along the road 68 that connects the first and third open spaces 62a and 62c, the road 68 is changed (e.g., the entrance of this road 68 becomes more easy to see, the road width broadens, or the like).

An information space providing system according to the second embodiment of the present invention will be described below. FIG. 3 is a block diagram showing an information space providing system 80 according to the second embodiment. Correspondence between components shown in FIG. 3 and those in the first embodiment is as follows.

estate server 82: information supply section 18

walker 84: agent who is in charge of each user in the user mediation section 22

traveler 86: data update section 28

world gate server 88: translation means 31, space search section 32

city server 92: agent who is in charge of each city in the space management section 34

material database 94: basic data file 42

city database 96: space management file 44

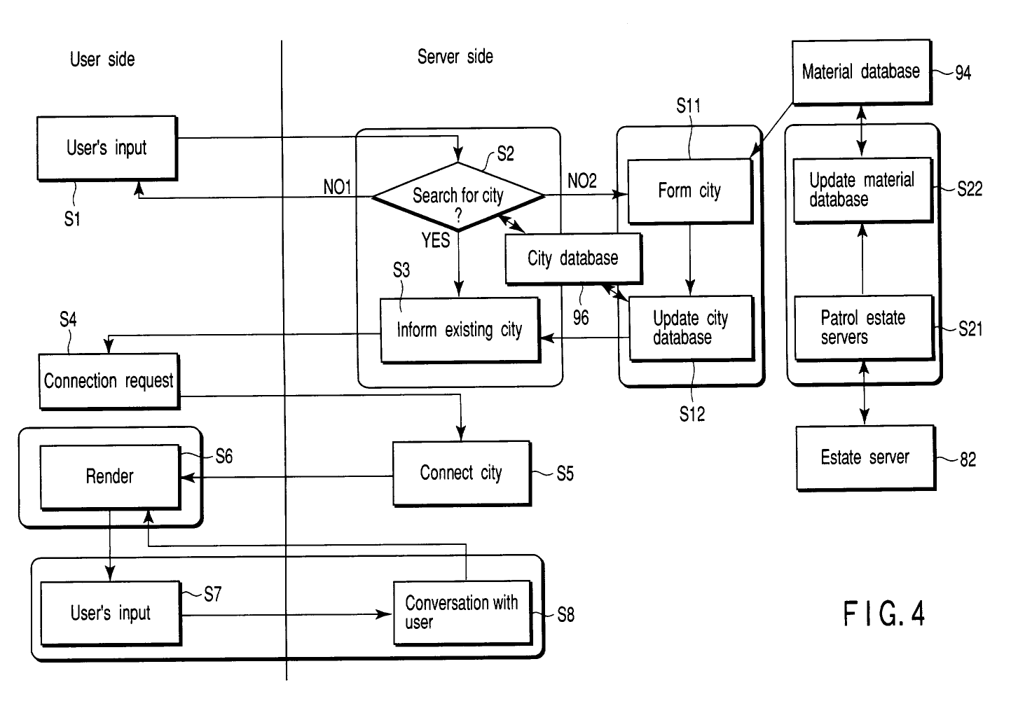

FIG. 4 is a flow chart until the user establishes connection to a city associated with information that he or she wants to get hold of in the second embodiment. The user inputs key data associated with information that he or she wants to get hold of in a walker 84, who sends this key data to the world gate server 88 (step S1). The world gate server 88 searches based on this key data to see if correspondence with a key symbol stored in the material database 94 can be determined, if a corresponding city is present in the city database 96, and so forth (step S2). If no correspondence with any key symbol stored in the material database 94 is determined (“NO1” in step S2), that result is returned to the user and the control prompts the user to re-input key data.

If a city associated with information that the user wants to get hold of is present in the city database 96 (“YES” in step S2), the world gate server 88 sends this result to the user via the walker 84 (step S3). If the designated city is OK, the user requests to establish connection to that city (step S4). This request is sent from the world gate server 88 to a city server 92 that is in charge of that city. The city server 92 connects this city to the walker 84 of the corresponding user (step S5) to render that city on a user terminal (step S6). The user makes input to the city server 92 via this city (step S7) to acquire required information from estate servers 82 or the like (step S8).

On the other hand, if no city associated with information that the user wants to get hold of is present in the city database 96 (“NO2” in step S2), the world gate server 88 instructs a given city server 92 to manage a new city. In response to this instruction, the city server 92 collects materials from the material database 94 and forms a new city (step S11). This new city is registered in the city database 96 (step S12). The world gate server 88 informs the user of this city via the walker 84 (step S3). If the formed city is OK, the user requests to establish connection to that city (step S4). The subsequent processes are the same as those in steps S5 to S8 above.

Note that the traveler 86 periodically patrols the estate servers 82 (step S21). If the traveler 86 finds a change in, e.g., contents of a given estate server 82, it updates correspondence between the estate servers 82 and key symbols and the like, which is stored in the material database 94 (step S22).

That is, when the user begins to explore information that he or she wants to know, the world gate server 88 checks first if a city associated with that information is already present. Information associated with existing cities is managed by the city database 96, and the above checking process can be implemented by searching the city database 96. If a relevant city has already been present, the user can visit the city where information he or she wants to know is prepared by connecting the walker 84 to the city server 92 which manages that city. If the world gate server 88 determines that the existing city cannot provide information that the user wants to know, a new city configured by such information is formed.

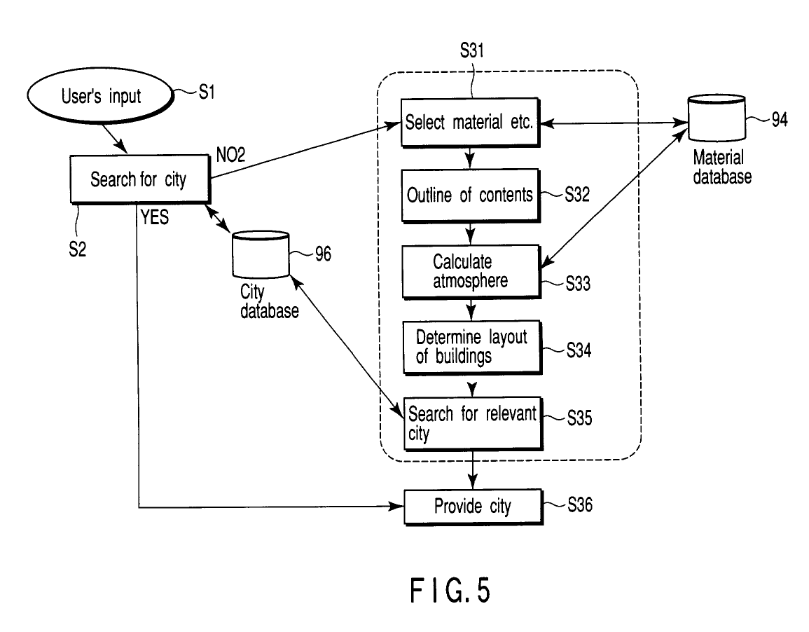

FIG. 5 is a flow chart until the user is provided with a city associated with information that he or she wants to get hold of in the second embodiment. As described above, the user inputs key data (step S1), and the world gate server 88 searches based on that key data if a corresponding city is present in the city database 96 (step S2). On the other hand, the traveler 86 periodically checks the contents of the estate servers 82 on the network, and stores their network addresses and outlines as a database (material database 94).

If no corresponding city is present in the city database 96 (“NO2” in step S2), the world gate server 88 instructs a given city server 92 to manage a new city. Upon forming a city, the city server 92 selects a group of contents similar to contents in which the user has an interest from the material database 94 (step S31). Furthermore, the city server 92 fetches the outlines (e.g., types or the like) of respective contents from the estate servers 82 as needed (step S32).

The search key data itself input by the user undergoes a semantic process to calculate an atmosphere of a city suitable for that key data (step S33). This process uses an atmosphere file in the material database 94. The atmosphere file is a dictionary, which stores suitable shapes, colors, and surfaces (textures and the like) of buildings, music, and the like in correspondence with respective words. Upon forming a city, a visually adequate city can be formed, using the information described above. For some contents, no building definitions for them are available. In such case, the buildings themselves can be automatically formed based on information in the atmosphere file.

A layout of buildings on the city is determined (step S34). The city server 92 prioritizes selected contents based on some criteria (e.g., hit counts of contents and the like), and lays them out in that order. Hence, the user can walk around a city in which the contents line up in an order from those that are more likely to be target contents for the user.

The city database 96 is checked to see if the existing cities include a city which has high affinity to the new city (step S35). If a city with high affinity is found, a road (city link) to that city is formed. When cities with high affinity are organically connected, a city group more useful for the user can be provided.

The city server 92 records information associated with the city, which is prepared, as described above, in the city database 96 as update information. The city server 92 then provides this city to the walker 84 of the corresponding user (step S36).

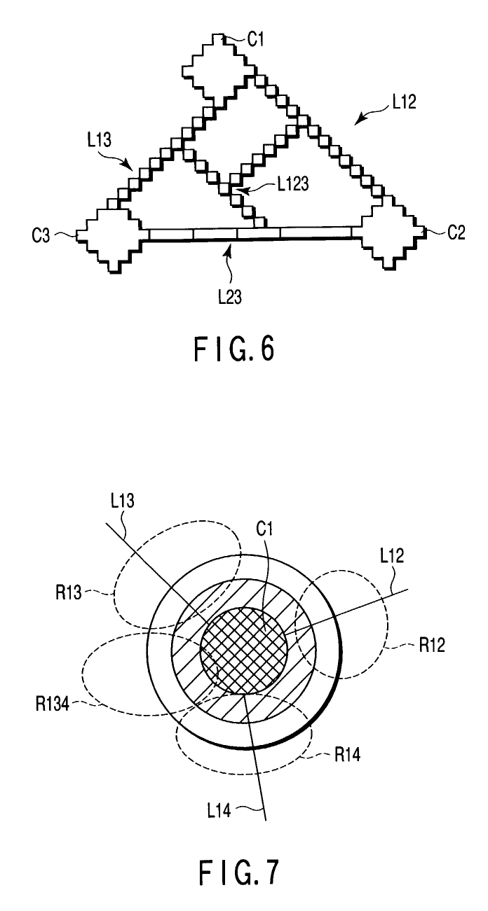

FIG. 6 shows the connection principle of cities as information space units in the second embodiment. Buildings arranged along roads which connect cities (building group having open spaces as their centers) C1 to C3 include a plurality of pieces of information. Cities C1 to C3 have information relevant to different first to third key symbols. Roads L12, L23, L13, and L123 respectively have information relevant to the first and second key symbols, second and third key symbols, first and third key symbols, and first to third key symbols.

For example, when the cities are connected, as shown in FIG. 6, buildings with contents relevant to both the first and second key symbols line up along road L12 that connects city C1 having information relevant to the first key symbol, and city C2 having information relevant to the second key symbol. As for their lineup order, buildings closer to city C1 have more pieces of information relevant to the first key symbol, but less pieces of information relevant to the second key symbol. By contrast, as buildings get closer to city C2, the number of pieces of information relevant to the second key symbol becomes larger than that relevant to the first key symbol, and the road is finally connected to city C2 formed by buildings consisting of only information relevant to the second key symbol.

FIG. 7 shows a basic concept of a typical layout of buildings in a city as an information space unit in the second embodiment. City C1 having information relevant to the first key symbol is formed to have an open space as the center. Roads L12, L13, and L14 which respectively extend toward cities having information relevant to the second, third, and fourth key symbols are connected to the open space. Regions R12, R13, R14, and R134 respectively have information relevant to the first and second key symbols, first and third key symbols, first and fourth key symbols, and first, third, and fourth key symbols.

In city C1, buildings are located around an open space, and include a large number of pieces of information relevant to the first key symbol. Typically, buildings with higher priority are located near the center around the open space, and buildings having less relevant information (with lower priority) are located near the perimeter. For this reason, a plurality of pieces of information relevant to the first key symbol are laid out in a radially spread pattern, as shown in FIG. 7.

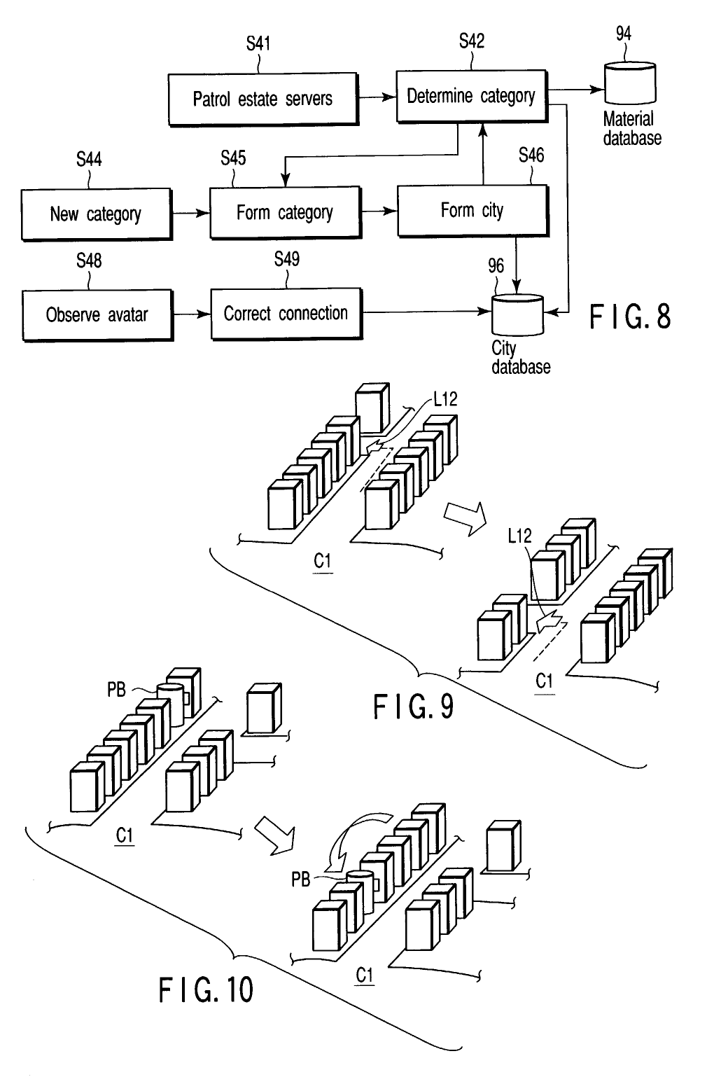

FIG. 8 is a flow chart showing a process for updating the material database 94 and city database 96 in the second embodiment. The material database 94 stores the network addresses, outlines of contents, and priority information of the estate servers 82. Respective pieces of site information are categorized (e.g., in a tree pattern) according to some policy, and when information that the user wants perfectly matches a given category, the user can immediately access a site in that category.

The traveler 86 periodically patrols and checks the estate server 82 on the network (step S41). For example, if the traveler 86 finds a new estate server 82 (contents), it registers the new estate server in the material database 94. On the other hand, if an existing estate server 82 disappears, the traveler 86 deletes information about that server. If a new estate server 82 is found, the traveler 86 executes a semantic process to determine a category of contents in which that server is suitably registered (step S42). As a result of checking, if the category of the new estate server matches an existing category, that estate server is registered in that category. If the category of the new estate server does not match any existing category, a new category is formed.

A new category may be found upon input from the user (step S44). In such case, formation of a new category (step S45) and formation of a new city (step S46) are executed at the same time, and the material database 94 and city database 96 are updated.

The city database 96 stores information including the names of existing cities, connection states among cities, and the like. The city database 96 is updated when a new city is formed, when the internal configuration of a given city has changed, a connection state with other cities has changed, and so forth. The city database 96 is drastically updated when a new city is formed in response to a user's request. In this case, the formed city and its connection information are additionally stored in the city database 96.

Furthermore, more constructively, the city server 92 monitors the city database 96 to update it based on the statistical result of information. That is, the city server 92 observes movements of users (characters; e.g., avatars) in a given city, and checks the degree of deviation of user's interests on the initial key symbol (step S48). The city server 92 updates the information in the city database 96 based on that result as needed. For example, if it is found that the user's interests have changed, the city server strengthens or weakens the connection state among cities as information space units, or forms a new connection between cities (step S49).

FIG. 9 shows a practical example upon statistically updating the connection state among cities in the second embodiment. Assume that it is detected based on the statistical result that most of users who are in city C1 having information relevant to the first key symbol move to city C2 having information relevant to the second key symbol. In this case, a connection from city C1 to city C2 is strengthened by some method. For example, as shown in FIG. 9, road L12 to city C2 is broadened, or road L12 to city C2 is emphasized to make users easier to reach city C2. In this manner, affinity connection between cities can be attained based on the records. Conversely, when nearly no users go to city C2, the connection is weakened, or is cut off if that traffic becomes lower than a given threshold. Such update information is reflected in the city database 96.

FIG. 10 shows a practical example upon statistically updating the internal configuration of the city in the second embodiment. Buildings (contents) in the city where users frequently visit are relocated on the center side of the city, but buildings (contents) where users visit less frequently are relocated on the outer side of the city. This is because buildings where users visit frequently may be loaded with required information. For example, as shown in FIG. 10, popular building PB in city C1 is moved toward the center of the city. With this update process, since a state wherein buildings (contents) that the user wants are highly likely to be present near the center of the city can be provided to the user, the user need only walk around the center of the city.

FIG. 11 shows a practical example of an information space using the atmosphere file in the material database in the second embodiment.

Since each city is formed in correspondence with search key data (translated into a key symbol) input by the user, the outer appearance of that city preferably creates an atmosphere suitable for that key symbol. For this purpose, the atmosphere file is prepared as data used to create a more suitable atmosphere. The atmosphere file stores colors, surface information (textures and the like), sounds, music, and building shapes suitable for respective words. The atmosphere file is a dictionary, in which the aforementioned kinds of information are appended to all words.

When the user inputs new key data which is not registered in the atmosphere file, “default” is set at that time, and a city with a “default” atmosphere is formed. After that, the new key data undergoes a conceptual process by some method to append various kinds of information suitable for that new key data. When a given user wants to get hold of “Chinese dishes”, a city shown in FIG. 11 is formed if the atmosphere file is used correctly. By always creating an adequate atmosphere, adequate recognition can be provided to the user.

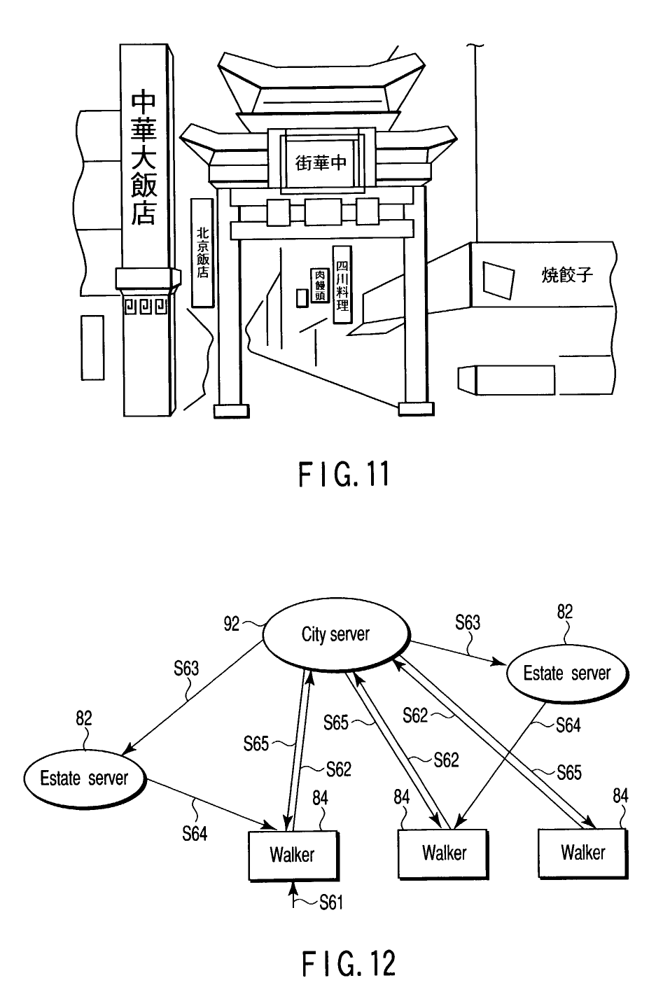

FIG. 12 is a flow chart showing communications in the second embodiment. In the information space providing system 80 of this embodiment, communications such as conversations between avatars that represent users, avatar's feeling expressions and actions, conversations between an avatar and object, and the like are made so as to exchange information.

The user inputs information (self avatar's comment, selection of a building, or the like) to the city server 92 (step S62) via the walker 84 (step S61). To do nothing is one of actions. The city server 92 informs an estate server 82 represented by a building of an item associated with the building in the input (step S63). Also, the estate server 82 provides information to the walker (avatar) 84 of the relevant user (step S64).

The city server 92 informs the walker 84 of the user represented by the avatar of an item associated with the avatar (step S65). In response to this information, the walker 84 informs the city server 92 of user's action (step S62). That is, avatars that represent users can have a conversation via the city server 92.

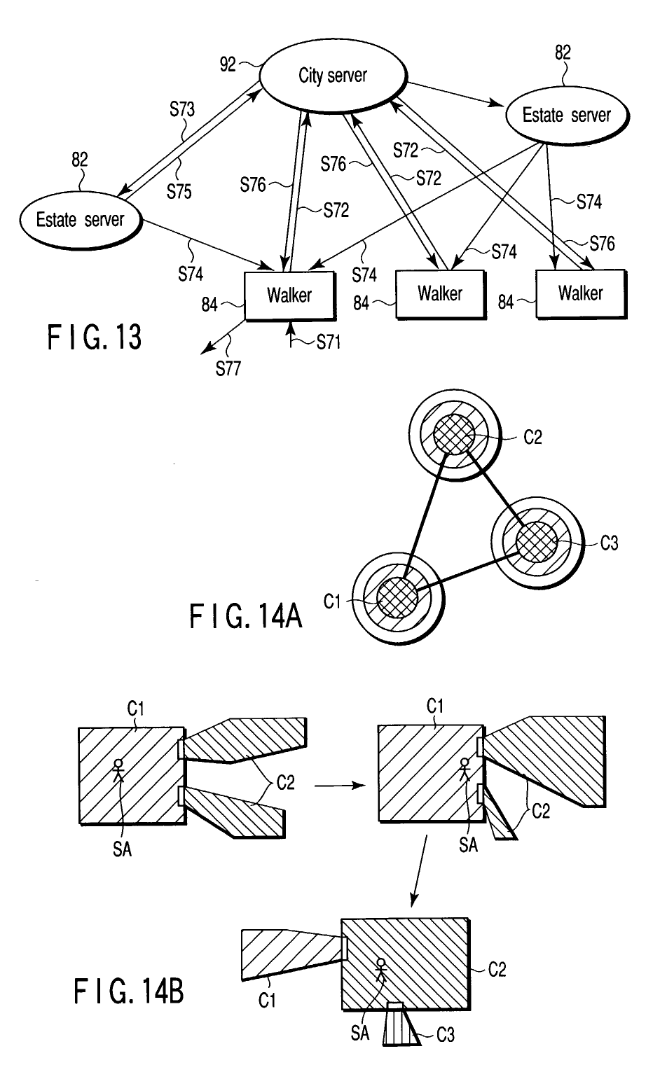

FIG. 13 is a flow chart showing a city rendering process in the second embodiment. The walker 84 forms an environment in which the user can easily access required information by three-dimensionally rendering buildings relevant to information that the user wants to get hold of and other avatars that have an identical interest on the screen of the user terminal. For this purpose, the walker 84 is provided with the following information.

Connection information among cities: This information is provided by the city server 92.

Information of the entire city, e.g., location information of buildings, locations of objects (ground, roads, trees, and the like) other than buildings, image information: Such information is provided by the city server 92.

Information of each building, e.g., information of an outer shape, surface, and the like: Such information is provided by the material database 94 or information of the estate server is provided via the city server 92 (it may be changed by the city server 92).

Contents information in each building: this information is provided by the estate server.

Information of other clients, e.g., information such as locations, actions, conversations, features, and the like of other avatars: Such information is provided by the city server 92.

These pieces of information are provided in the flow shown in FIG. 13 to execute a rendering process. That is, the user inputs information (key symbol, self avatar's movement, selection of a building, or the like) to the city server 92 (step S72) via the walker 84 (step S71). The city server 92 selects buildings and avatars required for rendering. The city server 92 informs estate servers represented by buildings required for rendering of relevant information (step S73).

Each estate server 82 communicates with the walker 84 to provide information required for rendering (typically, information required after the self avatar enters the site of a given building) (step S74). Also, the estate server 82 also informs the city server 92 of required information (shape, surface, and the like) so as to form an atmosphere of the city (step S75). The city server 92 provides information required to render a city to the walker 84 after it forms an atmosphere of the city (step S76). The city server 92 makes similar communications in association with actions of other avatars. The walker 84 renders an image in consideration of the relationship between the self avatar, and stationary objects of the city such as the ground, walls, and the like (step S77).

FIGS. 14A and 14B respectively show a basic concept associated with connections among cities, and a rendering example.

As shown in FIG. 14A, the interior of each of cities C1 to C3 is formed as a 3D space, but the cities are connected, as shown in FIG. 14A, and it is difficult to display them as a 3D space without contradiction. However, when the periphery of connected portions is continuously rendered in accordance with the location of self avatar SA, as shown in FIG. 14B, seamless connection can be implemented.

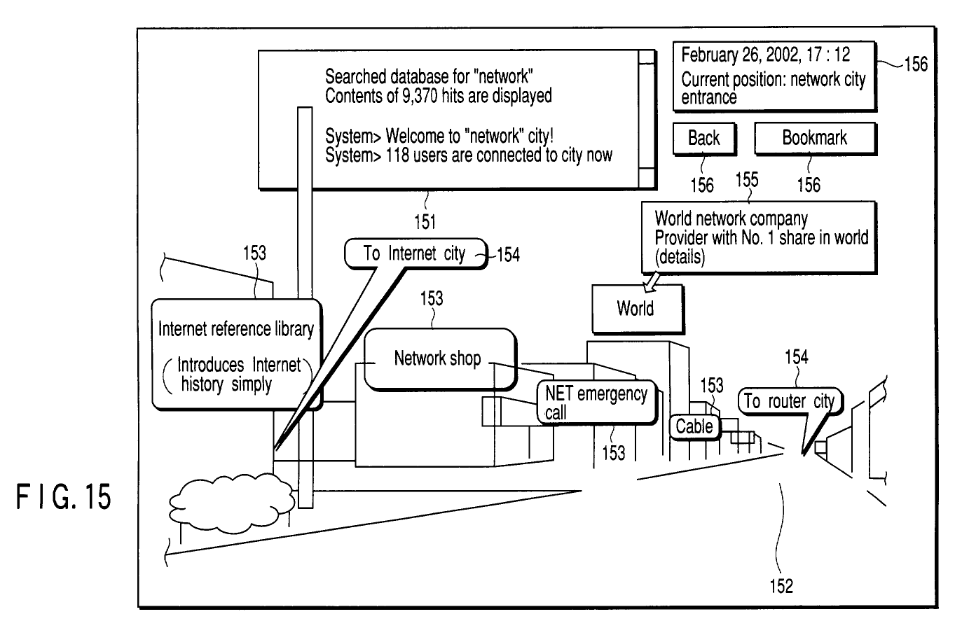

FIG. 15 shows a display example of an information space in the second embodiment. In this display example, required information can be efficiently provided to the user by displaying some of rendered buildings and information (comments for contents) on windows. FIG. 15 shows a state of a world formed after a search for a given event has been conducted. Each set of contents is expressed as a structure such as a building, signboard, tree, or the like, and the user can collect information by walking around that world. A road is connected to a world of information relevant to a given event (“network” in the example in FIG. 15), and the user can walk along that road to reach the world formed based on contents relevant to that event.

Contents are described using a given language (html, xml, or other world description languages that will become available in the future). A client connected to a server interprets that language, and graphically displays the state of that world in this example. Detailed information of each set of contents is displayed graphically or by means of text or a voice. The user connected to the world can obtain information of each set of contents by input via a keyboard, mouse, voice, or the like.

The contents line up along a road in descending order of importance of the searched event. In the world formed by a 3D space, contents on the near side have higher importance, and contents on the far side have lower importance. In the 3D space, contents on the near side are displayed using a broader area of the screen. For this reason, as shown in FIG. 15, information on the near side is displayed in detail to have a large scale, and information on the far side is displayed simply.

In the display example shown in FIG. 15, a main window 151 is used to display information from the information space providing system 80 and to input commands and the like. A road 152 is connected to respective worlds (cities, open spaces). A contents information window 153 is used to display information associated with contents (a building in this case). A direction window 154 teaches the user about a place to which the road is connected. When details 155 are displayable using a pointer, the detailed contents of information in which the user has an interest can be displayed. Also, tools 156 (time, position, and the like, and key buttons [back] and [bookmark]) that help the user can be displayed.

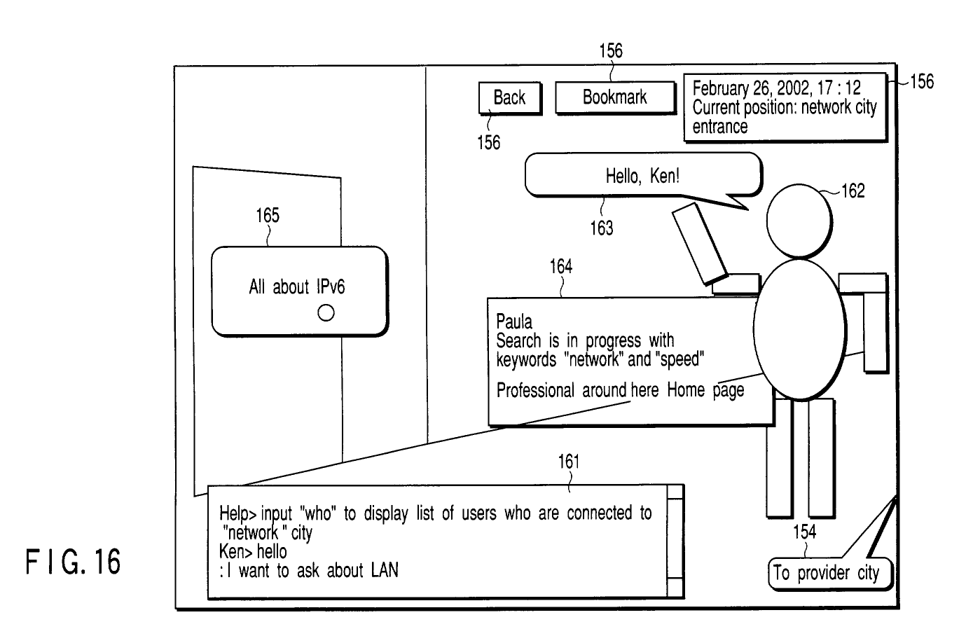

FIG. 16 shows another display example of an information space in the second embodiment. This display example relates to communications among users via the information space. The users provided with the information space can communicate with each other via their avatars. As a communication means, an existing text- or voice-based Chat system is used. FIG. 16 shows the state wherein the users communicate with each other via an avatar.

The user need not search alone a world created for information of a given search key, but can ask an authority on such information, can search contents together with other users, or can visit contents together with other users. For this reason, the user can acquire helpful information quicker than conventional web browsing. Dialogues with other users are input as text via a keyboard or a voice, and are output as text on a screen or a voice. Users who are in an identical information space can communicate with each other even when they are not within hailing distance. Also, an arbitrary user's sight can be transferred to another arbitrary user.

In the display example shown in FIG. 16, a main window 161 is used to display information from the information space providing system 80 and to input text for Chat or the like. An avatar 162 represents another user. Speech of another user is output as text on a speech balloon 163 or as a voice. When details 164 are displayable using a pointer, the detailed contents of information in which the user has an interest can be displayed. A contents information window 165 displays information about contents.

In order to facilitate communications with other users, and to pull up information easier, the following support functions such as summon, teleport, group gate, replay post, and the like can be set in the information space.

[Summon, Teleport, Group Gate]

Since the information space is a virtual world, even when the user visually feels distant, such distance exists to merely systematically lay out contents in the order of their importance. That is, the distance in the information space has no significance in respect of moving distance, walking speed, and the like. Summon, teleport, and group gate are functions of supporting a plurality of users to get hold of given information together.

Summon: This function is used, for example, when a plurality of users separately search a space formed based on a given search key, and one of these users finds target contents. In this case, the current positions of other users are quite different. In a real world, such users must give directions to the target place using portable phones or the like, or must temporarily meet in a common place. However, this wastes time required until they meet. Summon is a function of summoning other users to a place near a given user with a consensus of other users. With this function, an extra overhead required for meeting can be reduced.

Teleport: This function is similar to but functionally opposite to summon, and teleports an arbitrary user (including oneself) to given contents, space, or the like. If this function is used for a given user himself or herself, he or she can teleport to his or her favorite contents. If this function is used for another user, the given user can make that user teleport to a required place without giving directions to that place.

Group Gate: This function can apply the teleport function to a group, i.e., can teleport not an individual but a group to an arbitrary place.

[Replay Post]

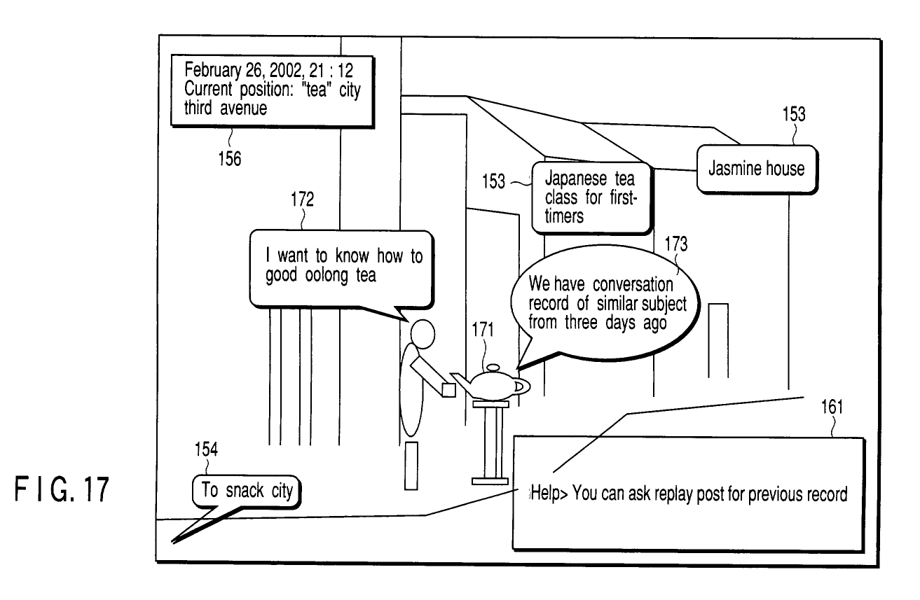

The replay post is a generic term of a function that can present an episode, conversation, or the like at a given place of a city to the user irrespective of time. FIG. 17 shows a display example of an information space that includes a replay post 171 in the second embodiment. In response to an inquiry from a self avatar (inquiry window 172), a replay post 171 replies previous records (reply window 173). The replay post 171 has the following features.

Store conversations, actions, and the like of avatar: The replay post 171 records episodes as they are. Also, the replay post 171 arranges conversations and the like to form a database.

Indefinite shape: The replay post 171 has a shape suitable for an episode, the contents of conversation, or the like.

Management on city server 92: A building can be present in a plurality cities, but only one replay post is present per city. Each building can acquire information from the replay post, and can use that information to update itself. Since the replay post is present in a city in an arbitrary form and provides information, it can be considered as one building.

Methods of providing information to the user are as follows.

Replay: This method directly shows a previous episode, but does not allow any conversation.

Time Travel: This method allows a user to travel to that time, and to hear only conversation.

Search: This method provides only information that the user wants.

The information space providing system 80 according to the second embodiment displays contents by the following three methods. (a) The system 80 displays contents using text and 2D graphics like an existing home page. In this case, existing html, xml, or the like may be directly displayed. (b) The system 80 graphically displays contents. (c) The system graphically displays contents using a realtime video (cooperation with a real world).

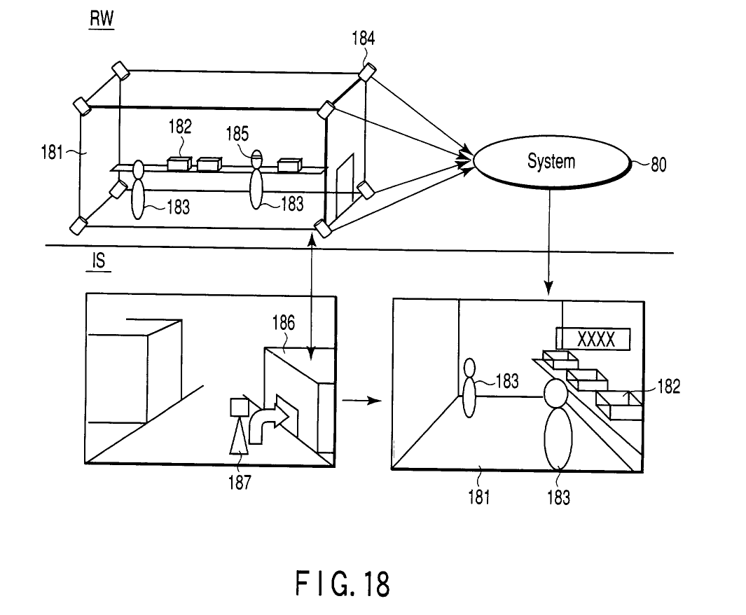

FIG. 18 shows a basic concept of cooperation between information space IS and real world RW in the second embodiment. In FIG. 18, a given shop 181 exists in real world RW, and information (an image including articles 182 and persons 183, or the like) of that shop 181 is captured in real time by cameras 184. By contrast, a building 186 corresponding to the shop 181 is set in information space (virtual space) IS of the information space providing system 80.

When an avatar 187 has entered the building 186 on the virtual space, the information space providing system 80 re-composites the image in the shop 181 from the viewpoint of the avatar 187 on the basis of information of real world RW captured in real time. In this case, the user in information space IS can have conversation with the persons 183 in the shop 181 in real world RW. For example, when a person in real world RW wears a see-through head-mounted display 185 with a built-in walker 84, microphone, and the like, such conversation can be implemented.

When the user purchases an article in the shop on-line in the information space, he or she can receive data that can be used in the information space. For example, when the user purchases a dress on-line, he or she receives the same dress (but digital data) as that he or she purchased in the information space, and his or her avatar can wear that dress.

According to the information space providing system according to the first and second embodiments, the following merits are obtained.

The BBS and Chat systems can implement realtime/non-realtime communications, but subjects are provided by participants or manager. Also, a user cannot often find a BBS or Chat site optimal to him or her, and there is no assurance that the user can meet a partner with whom he or she wants to communicate.

By contrast, with the information space providing system according to the embodiments of the present invention, an information space associated with a designated keyword is automatically generated, and persons who have an interest in similar keywords are placed in that space. More specifically, an optimal communication site is automatically generated. In this manner, the user can easily and promptly communicate with partners who have a common interest in real time. Unlike a BBS or Chat system, a world that the user wants always exists. Unlike a conventional 3D Chat system in which the user can act only within a limited world, since a world is built as needed by capturing already existing sites, the user can act in an unlimited space.

In terms of an information collection tool, the search engine can only collect information on the Internet. That information is provided to only a person who conducted a search, and there is no means for acquiring extra information.

By contrast, with the information space providing system according to the embodiments of the present invention, since persons who have an interest in similar keywords are placed in an identical world simultaneously with a search, the user can acquire information that he or she wants to know from another user. Since information found by search is expressed by a graphical information space, the user can share the found information with other users in an easy-to-understand form. In this manner, since an information space is generated dynamically, communications and information collection can be done more effectively than those done by the conventional tools.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A system for providing an information space on a network, comprising:
a user mediation section configured to selectively exchange information with a plurality of users;
a supply mediation section configured to selectively exchange information with a plurality of information supply sections;
a basic data management section configured to store basic data including a table that indicates correspondence between the information supply sections and a plurality of key symbols, and a plurality of image materials used to form an information space; and
a space management section that includes a space producer which selects, in response to an input key symbol that represents a search target of each user, information supply sections relevant to the key symbol and image materials that represent the information supply sections from the basic data with reference to the table, and forms an information space corresponding to the key symbol using the selected image materials, and a space manager which provides each information space to a corresponding user via the user mediation section while placing a character that substitutes for actions of the corresponding user in the information space, and manages the information space to allow the corresponding user to selectively access an arbitrary information supply section via the supply mediation section by selecting an image material in the information space.

2. A system according to claim 1, further comprising a space search section configured to search a plurality of existing information spaces stored in the space management section for a space corresponding to or associated with the key symbol in response to the input key symbol, and wherein when the space search section finds a relevant space, the space search section informs the space management section of the found space as an information space corresponding to the key symbol, and when the space search section cannot find any relevant space, the space search section instructs the space management section to form an information space corresponding to the key symbol.

3. A system according to claim 1, further comprising a data update section configured to periodically or non-periodically patrol the information supply sections and to update the basic data on the basis of a change in the information supply sections.

4. A system according to claim 1, wherein the space management section places a plurality of characters that represent a plurality of users as sources of mutually associated key symbols to a common information space.

5. A system according to claim 4, wherein the plurality of characters can have a conversation in the information space.

6. A system according to claim 5, wherein the space management section has a function of recording and playing back a conversation or action of a character that represents a user who visited each information space previously.

7. A system according to claim 1, wherein the space management section provides to a corresponding user a plurality of information space units, which are formed based on a plurality of mutually associated key symbols, while connecting the information space units via connectors on an image on which a character that represents an action of each user can move.

8. A system according to claim 7, wherein image materials laid out along the connector which connects first and second information spaces formed based on first and second key symbols become less relevant to the first key symbol, but more relevant to the second key symbol from the first information space toward the second information space.

9. A system according to claim 7, wherein the space management section changes the connector depending on a frequency of use of the connector.

10. A system according to claim 1, wherein the space management section assigns different image materials as those which represent the information supply sections in accordance with a key symbol so that the information space has an atmosphere that matches the key symbol.

11. A system according to claim 1, wherein image materials are located in the information space in accordance with a specification selected by each user.

12. A system according to claim 1, wherein the information space is a three-dimensional space.

13. A system according to claim 12, wherein image materials which represent the information supply sections with higher relevancy to a key symbol are displayed on a near side to have a larger scale in the information space.

14. A system according to claim 13, wherein buildings as the image materials are laid out radially around an open space in the information space.

15. A system according to claim 12, wherein the image materials include an image material captured from a real space.

16. A system according to claim 1, wherein a comment that explains the information supply section is displayed on a window in the information space.

17. A system according to claim 1, wherein translation means configured to translate key data selected from the group consisting of a word, picture, and sound, input from each user via the user mediation section, into the key symbol is connected to the space management section.

18. A method of providing an information space onto a network using a system which has a user mediation section configured to selectively exchange information with a plurality of users, and a supply mediation section configured to selectively exchange information with a plurality of information supply sections, comprising:
storing basic data including a table that indicates correspondence between the information supply sections and a plurality of key symbols, and a plurality of image materials used to form an information space;
selecting, in response to an input key symbol that represents a search target of each user, information supply sections relevant to the key symbol and image materials that represent the information supply sections from the basic data with reference to the table, and forming an information space corresponding to the key symbol using the selected image materials; and
providing each information space to a corresponding user via the user mediation section while placing a character that substitutes for actions of the corresponding user in the information space, and managing the information space to allow the corresponding user to selectively access an arbitrary information supply section via the supply mediation section by selecting an image material in the information space.

19. A method according to claim 18, further comprising searching a plurality of existing information spaces stored in the system for a space corresponding to or associated with the key symbol in response to the input key symbol, and wherein when a relevant space is found, the found space is used as an information space corresponding to the key symbol, and when no relevant space is found, the information space corresponding to the key symbol is formed.

20. A method according to claim 18, further comprising periodically or non-periodically patrolling the information supply sections and updating the basic data on the basis of a change in information supply section.

21. A method according to claim 18, further comprising placing a plurality of characters that represent a plurality of users who input relevant key symbols in a common information space.

22. A method according to claim 21, further comprising allowing the plurality of characters to have a conversation.
